(19) United States
(12) Patent Application Publication
(10) Pub. No.: US 2007/0284412 A1
(43) Pub. Date: Dec. 13, 2007

(54) Solder flux composition

(76) Inventors: Anna M. Prakash, Chandler, AZ (US); Vassou LeBonheur, Tempe, AZ (US); Stephen E. Lehman, Chandler, AZ (US); Paul A. Koning, Chandler, AZ (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/444,738

(22) Filed: May 31, 2006

(51) Int. Cl. A47J 36/02

(52) U.S. Cl. 228/101

(57) ABSTRACT

A composition, a method, and a system for a solder flux are disclosed herein. In various embodiments, a solder flux composition may comprise a surfactant and less than about 20% of a carboxylic acid. In some of these embodiments, the solder flux composition may be used in lead-free soldering processes.

### TECHNICAL FIELD

Embodiments of the invention relate generally to the field of integrated circuit packaging, specifically to methods, apparatuses, and systems associated with and/or using solder flux.

### BACKGROUND

In the field of integrated circuit (IC) technology, IC components such as microprocessors typically are assembled into packages that are physically and electrically coupled to a substrate such as a printed circuit board (PCB). The packages themselves normally comprise of one or more IC components and one or more substrates. Each of these components typically comprises multiple electrical contacts or conductive pads that are used to couple with other components. For example, electronic packages will usually have multiple contact or conductive pads used to couple with, for example, the PCB substrate.

In order to electrically couple these electronic packages to the PCB substrate, the contact pads of the electronic packages may be coupled to conductive connectors such as solder bumps, pins, etc., that may be further electrically coupled to the PCB substrate. With respect to soldering, a flux may be used to improve the electrical connection between a surface (e.g., a contact pad) and the soldering material.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a method for soldering incorporated with the teachings of the present invention, in accordance with various embodiments; and

FIG. 2 illustrates a system incorporated with the teachings of the present invention, in accordance with various embodiments.

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B),” that is, A is optional.

According to various embodiments of the present invention, provided are a novel solder flux composition including surfactant and acid additives, methods for using a solder flux composition, and systems endowed with components prepared using a solder flux composition.

In various embodiments, the novel solder flux composition or combined composition may be used as part of a soldering process for forming various integrated circuit devices. For the embodiments, a solder flux composition may remove oxide from a surface onto which soldering is to occur thereby increasing the ability of the solder to adhere to the surface of the substrate. In some embodiments, a solder flux composition may prevent oxide growth on a surface to be soldered as well as decreasing air and/or contaminants at the surface of the substrate.

For some embodiments, a solder flux composition may comprise an acid additive having a low weight percentage (with respect to the solder flux composition) and in some of these embodiments, the low weight percentage may reduce the amount of degassing, bubbling, and/or hardening of a solder flux during thermal processing (e.g., reflow).

In various embodiments, a low weight percentage of acid may be particularly beneficial for high-temperature reflow process common for lead-free soldering processing. In current formulations of solder flux, certain devastating problems may result from high-percentages of acid. For example, degassing, bubbling, and/or flux hardening may result. Degassing and/or bubbling are undesirable due to their potential to cause die misalignment. Further, hardening may be an issue with high weight percentages of acid in that the acid may interact with other components of a solder flux, cross-linking and/or creating esters which may cause a flux residue to be difficult to remove with water. Thus, in various embodiments, a low weight percentage of acid may reduce die misalignment and/or improve cleanability of flux residue.

Acid additives in accordance with various embodiments may be one or more carboxylic acids. For example, in some embodiments, an acid additive may be a dicarboxylic acid. In various ones of these embodiments, a dicarboxylic acid may any one or more of, for example, malonic acid, succinic acid, glutaric acid, adipic acid, pimelic acid, and/or tartaric acid. In various other embodiments, an acid additive may be any one or more of other carboxylic acids including, for example, glycolic acid.

As alluded to previously, an acid additive in accordance with various embodiments may have a low weight percentage. In some embodiments, a solder flux composition may comprise less than about 20 weight % of a carboxylic acid. In various embodiments, a weight percentage of acid additive having less than 30 weight % loss at reflow temperatures may be used. For example, in some embodiments, an optimal result may be achieved by using a solder flux composition comprising between about 1 and 7 weight % of a carboxylic acid. In various ones of these embodiments, a solder flux composition comprising about 6.3 weight % of a carboxylic acid may provide minimal flux degassing during reflow processes.

As mentioned previously, a solder flux composition may comprise a surfactant additive in various embodiments. In various ones of these embodiments, a surfactant additive may reduce the surface tension at the interface of flux residue (e.g., residue remaining after reflow processes) and water thereby enabling the water to remove the flux residue effectively from a surface of a substrate. A surfactant additive in accordance with various embodiments may be one or more commercially-available surfactants. For example, in some embodiments, Envirogem AD01 surfactant sold by Air Products and Chemicals, Inc. may be used as a surfactant additive. Other surfactants may be enlisted in accordance with various embodiments.

In various embodiments, a solder flux composition may comprise less than about 10 weight % of a surfactant additive. In various ones of these embodiments, an optimal result may be achieved by using a solder flux composition comprising about 2 weight % of a surfactant additive.

A solder flux composition in accordance with various embodiments may comprise an amine additive. In some of these embodiments, an amine additive may comprise one or more of, for example, an alkyl substituted amine, an ethanol amine, an ethoxylated amine, and/or a propoxylated amine. In various embodiments, a solder flux composition may comprise less than about 40 weight % of an amine, and in various ones of these embodiments, optimal results may be achieved with about 20 weight % of an amine.

A solder flux composition in accordance with various embodiments may comprise other additives including, for example, a resin, a solvent, etc. In various embodiments, a solder flux composition may comprise less than about 40 weight % of a resin, and in various ones of these embodiments, optimal results may be achieved with about 30 weight % of a resin. In some embodiments, a solder flux composition may comprise a solvent additive including, for example, one or more of a diol, an ether, and/or an ether acetate.

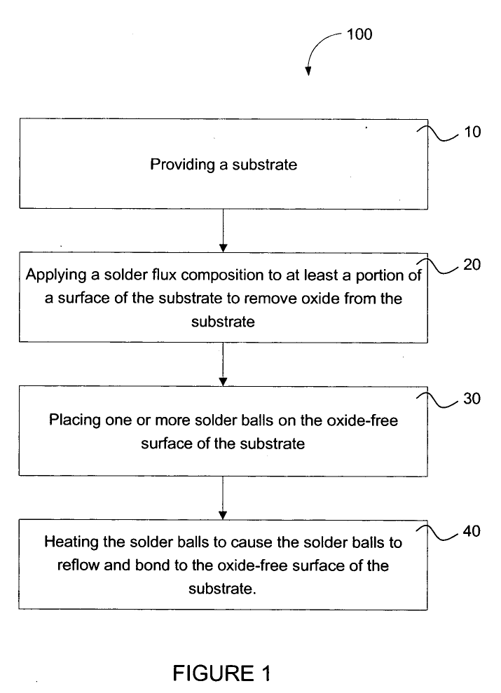

Referring now to FIG. 1, illustrated is a method in accordance with various embodiments. In various embodiments and as shown at 10 of FIG. 1, method 100 may comprise providing a substrate. As shown at 20, solder flux composition may be applied as needed to a surface of the substrate and in some embodiments, a solder flux composition may be applied to remove oxide from the surface of the substrate on which soldering is to occur. For example, in some embodiments, a solder flux composition may be applied to discrete locations on a substrate or may be applied to an entire surface of a substrate. In various other embodiments, a solder flux composition may be included in a solder material (e.g., mixed in with solder materials used to form a solder ball) in addition to or instead of applying a solder flux composition directly to a surface of a substrate.

In various embodiments, a solder flux composition may include any number of additives including, for example, an acid, a surfactant, etc. Acid additives in accordance with various embodiments may be one or more carboxylic acids including, for example, malonic acid, succinic acid, glutaric acid, adipic acid, pimelic acid, tartaric acid, and/or glycolic acid. In various embodiments, a solder flux composition may comprise less than about 20 weight % of a carboxylic acid and less than about 10 weight % of a surfactant. In some of these embodiments, optimal results may be achieved using between about 1 and 7 weight % of a carboxylic acid and/or about 2 weight % of a surfactant.

In various embodiments and as shown at 30 of FIG. 1, one or more solder balls may then be placed on the surface of the substrate after any oxide is removed by applying a solder flux composition. In various embodiments, solder balls may comprise lead-free, or substantially lead-free, solder balls. As mentioned previously, in various embodiments, a solder flux composition may be mixed in with solder materials used to form the solder ball. Further, in various embodiments, a solder flux composition may be applied directly to the surface of the solder balls. Still further, in various embodiments, a solder flux composition may be applied directly to a surface of a substrate.

In various embodiments and as shown at 40 of FIG. 1, solder balls may then be heated to cause the solder balls to reflow and bond to the oxide-free surface of the substrate. For example, in various ones of these embodiments, the solder balls may be reflown using conduction, infrared, laser, vapor phase and/or other reflow processing techniques.

In various embodiments, the substrate may be defluxed after reflow processes to remove any residue remaining on the substrate (not shown). In various embodiments, defluxing may comprise rinsing the substrate with water. In some of these embodiments, hot water may be used. In other embodiments, the substrate may not require defluxing or may be defluxed using other known rinsing solutions.

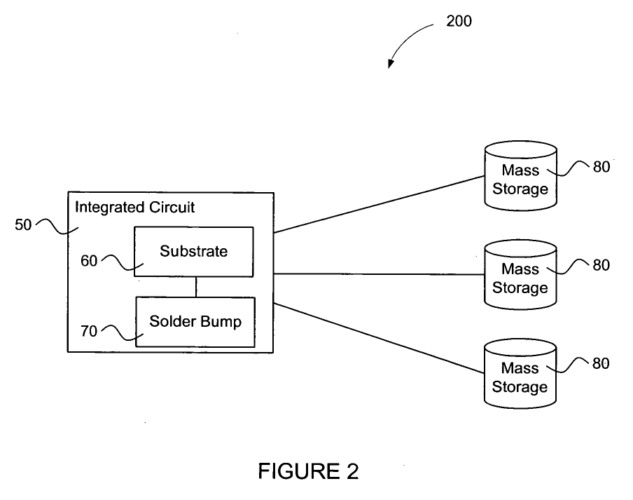

Turning now to FIG. 2, illustrated is a system 200 in accordance with various embodiments of the present invention. In various embodiments and as shown, system 200 may comprise an integrated circuit 50 and one or more mass storage devices 80 coupled to integrated circuit 50. In various ones of these embodiments, integrated circuit 50 may be variously configured. For example, integrated circuit 50 may comprise a substrate 60 and one or more solder bumps 70 coupled to a surface of the substrate 60, and in various ones of these embodiments, the surface of the substrate may have substantially all oxide removed using a solder flux composition of various embodiments of this invention.

With respect to solder bumps 70, in some embodiments, solder bumps may be variously formed and may be variously coupled to the substrate 60. For example, in some embodiments, the solder bumps may be formed by reflowing lead-free, or substantially lead-free, solder balls. Further, in various embodiments, solder bumps may be coupled to a surface of the substrate 60 having substantially all oxide removed using a solder flux composition comprising less than about 20 weight % of a carboxylic acid and less than about 10 weight % of a surfactant. Still further, in various embodiments, a solder flux composition may be mixed in with solder materials used to form a solder ball, applied directly to the surface of the solder ball, and/or applied directly to a surface of the substrate 60.

In various embodiments, mass storage device 80 and integrated circuit 50, except for teachings of embodiments of the invention incorporated therein, represent a broad range of elements known in the art. For example, mass storage device 80 may be an optical storage, or a magnetic storage, such as a disk drive. Further, system 200 may be embodied in a broad range of form factors for a broad range of general or special applications including, for example, a wireless adaptor, a wireless mobile phone, a set-top box, a personal digital assistant, a tablet computing device, a desktop computing device, and/or an entertainment control unit. Further, system 200 may be endowed with various operating systems and/or applications to solve various computing problems.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A solder flux composition, comprising:
less than about 20 weight % of a carboxylic acid; and
less than about 10 weight % of a surfactant.

2. The solder flux composition of claim 1, comprising about 2 weight % of the surfactant.

3. The solder flux composition of claim 1, comprising between about 1 weight % and 7 weight % of the carboxylic acid.

4. The solder flux composition of claim 1, wherein the carboxylic acid comprises a dicarboxylic acid.

5. The solder flux composition of claim 4, wherein the dicarboxylic acid comprises a selected one of malonic acid, succinic acid, glutaric acid, adipic acid, pimelic acid, or tartaric acid.

6. The solder flux composition of claim 1, wherein the carboxylic acid comprises glycolic acid.

7. The solder flux composition of claim 1, further comprising an amine.

8. The solder flux composition of claim 7, wherein the amine comprises a selected one of an alkyl substituted amine, an ethanol amine, an ethoxylated amine, or a propoxylated amine.

9. The solder flux composition of claim 7, comprising less than about 40 weight % of the amine.

10. The solder flux composition of claim 9, comprising about 20 weight % of the amine.

11. The solder flux composition of claim 1, further comprising a resin.

12. The solder flux composition of claim 11, comprising less than about 40 weight % of the resin.

13. The solder flux composition of claim 12, comprising about 30 weight % of the resin.

14. The solder flux composition of claim 1, further comprising a solvent.

15. The solder flux composition of claim 14, wherein the solvent comprises a selected one of a diol, an ether, or an ether acetate.

16. A method, comprising:
providing a substrate;
applying a solder flux composition to at least a portion of a surface of the substrate to remove oxide from the substrate, the solder flux composition including less than about 20 weight % of a carboxylic acid and less than about 10 weight % a surfactant;
placing one or more solder balls on the oxide-free surface of the substrate; and
heating the solder balls to cause the solder balls to reflow and bond to the oxide-free surface of the substrate.

17. The method of claim 16, further comprising rinsing with water any residue remaining on the substrate after heating the solder balls.

18. The method of claim 16, wherein said placing one or more solder balls on the oxide-free surface of the substrate comprises placing one or more substantially lead-free solder balls on the oxide-free surface of the substrate.

19. A system, comprising:
an integrated circuit, including:
a substrate; and
one or more solder bumps coupled to a surface of the substrate having substantially all oxide removed using a solder flux composition comprising less than about 20 weight % of a carboxylic acid and less than about 10 weight % of a surfactant; and
one or more mass storage devices coupled to the integrated circuit.

20. The system of claim 19, wherein one or more of the solder bumps comprise substantially lead-free solder bumps.
